(19) United States
(12) Patent Application Publication
(10) Pub. No.: US 2009/0012764 A1
(43) Pub. Date: Jan. 8, 2009

(54) SYSTEM MODEL PRODUCTION SUPPORT APPARATUS AND SYSTEM MODEL PRODUCTION SUPPORT METHOD

(75) Inventor: Shinichi SOEJIMA, Gotenba-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/164,328

(22) Filed: Jun. 30, 2008

(30) Foreign Application Priority Data
Jul. 2, 2007 (JP) 2007-174467

(51) Int. Cl. G06G 7/70; G06G 7/48

(52) U.S. Cl. 703/8; 703/6

(57) ABSTRACT

In a system model production support apparatus and method, plural partial models are stored along with input/output information for each partial model; an input-side portion of the system model is produced by sequentially selecting the partial models constituting the input-side portion from among the stored partial models in an order starting from the partial model closest to an input-side end of the system model, based on input information for the system model, and the input/output information for each partial model, and sequentially connecting the selected partial models; an output-side portion of the system model is produced by sequentially selecting the partial models constituting the output-side portion from among the stored partial models in an order starting from the partial model closest to an output-side end of the system model, based on output information for the system, and the input/output information for each partial model, and sequentially connecting the selected partial models; and the produced input-side portion is connected with the produced output-side portion to produce the entire system model.

### BACKGROUND OF THE INVENTION

The disclosure of Japanese Patent Application No. 2007-174467 filed on Jul. 2, 2007, including the specification, drawings and abstract is incorporated herein by reference in its entirety.

### FIELD OF THE INVENTION

The invention relates to an apparatus and a method that support production of a system model.

### DESCRIPTION OF THE RELATED ART

An apparatus and a method, which calculate values indicating, for example, the behavior of an engine (internal combustion engine) or a vehicle based on a model such as a physical model, are available. For example, Japanese Patent Application Publication No. 2002-175338 (JP-A-2002-175338) describes a technology for producing a model used in the apparatus and the method, that is, a system model representing a system to be modeled or an entire system to be modeled. In the technology, the system or the like to be modeled is divided into a plurality of portions (that is, for example, when an intake system for an engine needs to be modeled, the intake system is divided into a throttle valve, an intake pipe, an intake valve, a cylinder, and the like). Each of the portions is modeled, and thus, partial models are produced. The partial models are combined to produce the system model.

Also, Japanese Patent Application No. 2005-167292 (JP-A-2005-167292) describes a technology for producing the system model, in which partial models for various portions are produced and prepared in a model storage device in advance; and when the system model is produced, necessary partial models are selected from among the partial models in the model storage device, and a desired system model of the entire system to be modeled is produced using the selected partial models, to increase the reusability of information such as the partial models, and to increase the efficiency of the development.

When the system model is produced in this manner, it is desirable that various partial models should be prepared in the model storage device, for example, to increase the reusability of information such as the partial models, to increase the range of the system models that can be produced, and to shorten a model development period. However, if an extremely large number of partial models are prepared in the model storage device, it is difficult for a producer of the system model to select the partial models necessary and appropriate for the system model to be produced. This may decrease the efficiency of producing the system model.

### SUMMARY OF THE INVENTION

The invention provides a system model production support apparatus and a system model production support method that make it possible to more efficiently produce a system model, when the system model is produced using at least one partial model prepared in advance.

The invention provides a system model production support apparatus and a system model production support method as described below.

An aspect of the invention relates to a system model production support apparatus that supports production of a system model of an entire system to be modeled, using a partial model of each portion constituting the system. The system model production support apparatus includes a model storage device that stores a plurality of the partial models, along with input information and output information for each of the partial models; an input-side portion production device that produces an input-side portion of the system model by sequentially selecting the partial models constituting the input-side portion of the system model from among the partial models stored in the model storage device in an order starting from the partial model located closest to an input-side end of the system model, based on input information for the system model, and the input information and the output information for each of the partial models, and sequentially connecting the selected partial models; an output-side portion production device that produces an output-side portion of the system model by sequentially selecting the partial models constituting the output-side portion of the system model from among the partial models stored in the model storage device in an order starting from the partial model located closest to an output-side end of the system model, based on output information for the system, and the input information and the output information for each of the partial models, and sequentially connecting the selected partial models; and a model connection device that connects the input-side portion of the system model produced by the input-side portion production device, with the output-side portion of the system model produced by the output-side portion production device, thereby producing the entire system model.

In the above-described system model production support apparatus, the partial models constituting the input-side portion of the system model are sequentially selected in the order starting from the partial model located closest to the input-side end of the system model, and the selected partial models are sequentially connected; and the partial models constituting the output-side portion of the system model are sequentially selected in the order starting from the partial model located closest to the output-side end of the system model, and the selected partial models are sequentially connected. Then, the input-side portion and the output-side portion of the system model, which are produced in the above-described manner, are connected with each other to produce the entire system model. Thus, it is possible to more efficiently produce the system model.

A user may input or select at least one of the input information and the output information for the system model. Also, the input information and the output information for the system model may be set according to the user. Further, the output information for the system model may be set according to the input information for the system model. Also, the input information for the system model may be set according to the output information for the system model.

In the above-described system model production support apparatus, the input-side portion production device may select the partial model located closest to the input-side end of the system model so that at least part of the input information for the partial model located closest to the input-side end of the system model matches the input information for the system model, the input-side portion production device may select the partial models so that at least part of the input information for one of each pair of the adjacent partial models, which is located closer to the output-side end of the system model than the other of the pair of the adjacent partial models is, matches the output information for the other of the pair of the adjacent partial models, and the input-side portion production device may connect the selected partial models; and the output-side portion production device may select the partial model located closest to the output-side end of the system model so that at least part of the output information for the partial model located closest to the output-side end of the system model matches the output information for the system model, the output-side portion production device may select the partial models so that at least part of the output information for one of each pair of the adjacent partial models, which is located closer to the input-side end of the system model than the other of the pair of the adjacent partial models is, matches the input information for the other of the pair of the adjacent partial models, and the output-side portion production device may connect the selected partial models. With the above-described system model production support apparatus, it is possible to more efficiently produce the system model.

In the above-described system model production support apparatus, when the partial model, which is located closest to the output-side end of the system model, in the input-side portion of the system model produced by the input-side portion production device is the same as the partial model, which is located closest to the input-side end of the system model, in the output-side portion of the system model produced by the output-side portion production device, the model connection device may connect the input-side portion of the system model with the output-side portion of the system model at the partial model. With the above-described system model production support apparatus, it is possible to more efficiently produce the system model.

The system model production support apparatus may further include a system model production condition setting device that sets a system model production condition that is taken into account when the system model is produced. When the system model production condition is set, only the system model that meets the system model production condition may be produced.

In the above-described system model production support apparatus, by setting the system model production condition, it is possible to suppress production of unnecessary system models, and to reduce the number of produced system models. As a result, it is possible to more efficiently produce a desired system model.

The user may input or select the system model production condition. Also, the system model production condition may be set according to the user. Further, the system model production condition may be set according to at least one of the input information and the output information for the system model.

In the above-described system model production support apparatus, at least one of a condition relating to the partial model to be used in the system model, a condition relating to a combination of the partial models to be used in the system model, and a condition relating to an output from the partial model in the system model may be set as the system model production condition.

In the above-described system model production support apparatus, particularly, it is possible to specify the configuration to be included in the system model, and to specify the output from the partial model located at an intermediate position in the system model so that the value of the output from the partial model is obtained when simulation is performed using the system model. Therefore, it is possible to efficiently produce a system model appropriate for the purpose of the simulation.

The above-described system model production support apparatus may further include a system model selection condition setting device that sets a system model selection condition used to select a specific system model from among the system models that are produced; and a system model selection device that selects the specific system model that meets the system model selection condition, from among the produced system models.

In the above-described system model production support apparatus, by setting the system model selection condition, it is possible to efficiently select a desired system model from among the produced system models. The user may input or select the system model selection condition. Also, the system model selection condition may be set according to the user. Further, the system model selection condition may be set according to at least one of the input information and the output information for the system model.

In the above-described system model production support apparatus, at least one of a condition relating to a required accuracy and a condition relating to a permissible computation time may be set as the system model selection condition. In the above-described system model production support apparatus, particularly, it is possible to specify the accuracy required in the simulation using the system model, and the computation time permitted in the simulation using the system model. Therefore, it is possible to efficiently produce a system model appropriate for the purpose of the simulation.

In the above-described system model production support apparatus, the system to be modeled may be a portion of a vehicle or the entire vehicle; the input information for the system model may be a control parameter that is changed to control the vehicle; and the output information for the system model may be a characteristic parameter showing an operating characteristic of the vehicle.

With the above-described system model production support apparatus, it is possible to efficiently obtain a desired system model in the development of the vehicle using the model. The control parameter may be, for example, an accelerator-pedal operation amount, a throttle-valve opening amount, an ignition timing, or a controlled variable relating to an actuator, which is controlled to change each of the accelerator-pedal operation amount, the throttle-valve opening amount, and the ignition timing. The characteristic parameter may be, for example, vehicle acceleration, generated torque, or a cylinder pressure.

Another aspect of the invention relates to a system model production support method that supports production of a system model of an entire system to be modeled, using a partial model of each portion constituting the system. The system model production support method includes storing a plurality of the partial models, along with input information and output information for each of the partial models; producing an input-side portion of the system model by sequentially selecting the partial models constituting the input-side portion of the system model from among the stored partial models in an order starting from the partial model located closest to an input-side end of the system model, based on input information for the system model, and the input information and the output information for each of the partial models, and sequentially connecting the selected partial models; producing an output-side portion of the system model by sequentially selecting the partial models constituting the output-side portion of the system model from among the stored partial models in an order starting from the partial model located closest to an output-side end of the system model, based on output information for the system, and the input information and the output information for each of the partial models, and sequentially connecting the selected partial models; and connecting the produced input-side portion of the system model with the produced output-side portion of the system model, thereby producing the entire system model. According to the above-described system model production support method, it is possible to more efficiently produce the system model.

In the system model production support method, the input-side of the system model may be produced by selecting the partial model located closest to the input-side end of the system model so that at least part of the input information for the partial model located closest to the input-side end of the system model matches the input information for the system model, selecting the partial models so that at least part of the input information for one of each pair of the adjacent partial models, which is located closer to the output-side end of the system model than the other of the pair of the adjacent partial models is, matches the output information for the other of the pair of the adjacent partial models, and connecting the selected partial models; and the output-side portion of the system model may be produced by selecting the partial model located closest to the output-side end of the system model so that at least part of the output information for the partial model located closest to the output-side end of the system model matches the output information for the system model, selecting the partial models so that at least part of the output information for one of each pair of the adjacent partial models, which is located closer to the input-side end of the system model than the other of the pair of the adjacent partial models is, matches the input information for the other of the pair of the adjacent partial models, and connecting the selected partial models. According to the above-described system model production support method, it is possible to more efficiently produce the system model.

In the system model production support method, when the partial model, which is located closest to the output-side end of the system model, in the input-side portion of the system model is the same as the partial model which is located closest to the input-side end of the system model, in the output-side portion of the system model, the input-side portion of the system model may be connected with the output-side portion of the system model at the partial model. According to the above-described system model production support method, it is possible to more efficiently produce the system model.

In the system model production support method, a system model production condition that is taken into account when the system model is produced may be set; and only the system model that meets the system model production condition may be produced. According to the above-described system model production support method, by setting the system model production condition, it is possible to suppress production of unnecessary system models, and to reduce the number of produced system models. As a result, it is possible to more efficiently produce a desired system model.

In the system model production support method, at least one of a condition relating to the partial model to be used in the system model, a condition relating to a combination of the partial models to be used in the system model, and a condition relating to an output from the partial model in the system model may be set as the system model production condition. According to the above-described system model production support method, it is possible to specify the configuration to be included in the system model, and to specify the output from the partial model located at an intermediate position in the system model so that the value of the output from the partial model is obtained when simulation is performed using the system model. Therefore, it is possible to efficiently produce a system model appropriate for the purpose of the simulation.

The above-described system model production support method may further include setting a system model selection condition used to select a specific system model from among the system models that are produced; and selecting the specific system model that meets the system model selection condition, from among the system models that are produced. According to the above-described system model production support method, by setting the system model selection condition, it is possible to efficiently select a desired system model from among the produced system models.

In the above-described system model production support method, at least one of a condition relating to a required accuracy and a condition relating to a permissible computation time may be set as the system model selection condition. According to the above-described system model production support method, it is possible to specify the accuracy required in the simulation using the system model, and the computation time permitted in the simulation using the system model. Therefore, it is possible to efficiently produce a system model appropriate for the purpose of the simulation.

In the above-described system model production support method, the system to be modeled may be a portion of a vehicle or the entire vehicle; the input information for the system model may be a control parameter that is changed to control the vehicle; and the output information for the system model may be a characteristic parameter showing an operating characteristic of the vehicle. According to the above-described system model production support method, it is possible to efficiently obtain a desired system model in the development of the vehicle using the model.

Thus, according to the aspects of the invention, it is possible to more efficiently produce the system model when the system model is produced using at least one partial model prepared in advance.

### BRIEF DESCRIPTION OF THE DRAWINGS

The features, advantages thereof, and technical and industrial significance of this invention will be better understood by reading the following detailed description of embodiments of the invention, when considered in connection with the accompanying drawings, in which:

FIG. 1 is a diagram illustrating the basic configuration of a system model production support apparatus according to an embodiment of the invention;

FIG. 2 is a conceptual diagram showing a manner in which a system model production process is performed in the system model production support apparatus according to the embodiment of the invention;

FIG. 3 is a diagram showing a system model in which additional input information is necessary, and which is produced in the system model production support apparatus according to the embodiment of the invention;

FIG. 4 is a diagram illustrating the configuration of a system model production support apparatus according to another embodiment of the invention;

FIG. 5 is a diagram illustrating the case where verification of an accuracy relating to a steady-state value is performed;

FIG. 6 is a diagram illustrating the case where verification of an accuracy relating to a transient value is performed;

FIG. 7 is a conceptual diagram showing selection of the system model; and

FIG. 8 is a diagram illustrating specific examples of the produced system model.

### DETAILED DESCRIPTION OF EMBODIMENTS

In the following description and the accompanying drawings, the present invention will be described in more detail with reference to embodiments.

Hereinafter, a system model production support apparatus and a system model production support method according to an embodiment of the invention will be described. The system model production support method used in the system model production support apparatus will be described through the description of the system model production support apparatus.

That is, the system model production support apparatus supports production of a system model of an entire system to be modeled using a partial model of each portion constituting the system to be modeled. More specifically, the system model production support apparatus is configured using a known type digital computer in which a RAM (Random Access Memory), a ROM (Read Only Memory), a CPU (microprocessor), and an input port and an output port are connected with each other by a bidirectional bus.

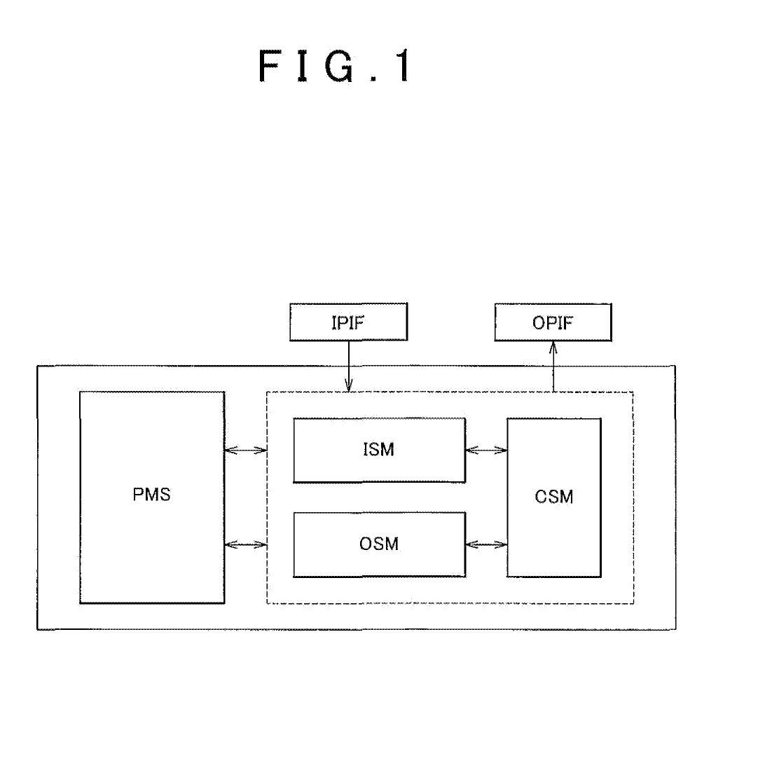

FIG. 1 is a diagram describing the basic configuration of the system model production support apparatus according to the embodiment. In FIG. 1, the reference character “IPIF” denotes an input device that inputs information necessary for producing a system model, to the system model production support apparatus. The reference character “OPIF” denotes an output device that outputs (or displays) the produced system model and the like. The reference character PMS denotes a model storage device that stores a plurality of partial models along with information relating to an input to each partial model (hereinafter, referred to as “input information for each partial model”) and information relating to an output from each partial model (hereinafter, referred to as “output information for each partial model”).

In FIG. 1, a portion surrounded by the dotted line indicates a portion where the system model is actually produced. The portion surrounded by the dotted line includes an input-side portion production device ISM that produces an input-side portion of the system model; an output-side portion production device OSM that produces an output-side portion of the system model; and a model connection device CSM that connects the input-side portion of the system model with the output-side portion of the system model, thereby producing the entire system model. In FIG. 1, each arrow indicates the flow of information.

Hereinafter, the production of the system model in the system model production support apparatus according to the embodiment will be described. That is, in the embodiment, a partial model of each portion constituting the system to be modeled is produced in advance and prepared in the model storage device PMS.

For example, when the system to be modeled is a mechanical apparatus, the partial model may be a model (component model) for each component of the mechanical apparatus. That is, for example, when the system to be modeled is an engine (internal combustion engine), the partial models may include a throttle model, a cylinder model, an intake pipe model, and an exhaust pipe model.

More specifically, the partial model is a physical equation (for example, an equation derived based on the law of conservation of mass or the law of conservation of energy), an approximate expression that is statistically derived, a map or the like that represents the characteristic of each portion of the system to be modeled. Each partial model is stored in the model storage device PMS along with the input information and the output information for the partial model.

In the system model production support apparatus according to the embodiment, the system model of the entire system is produced by selecting necessary partial models among partial models stored in the model storage device PMS, and combining the selected partial models. In this case, it is desirable that various partial models should be prepared in the model storage device PMS, for example, to increase the reusability of the information such as the partial models, to increase the range of the system models that can be produced, and to shorten a model development period. However, if an extremely large number of partial models are prepared in the model storage device PMS, it is difficult for a user to select the partial models necessary and appropriate for the system model to be produced. This may decrease the efficiency of producing the system model.

Accordingly, in the system model production support apparatus according to the embodiment, the following devices are used to more efficiently produce the system model. That is, when a system model of a specific system to be modeled is produced using the system model production support apparatus according to the embodiment, first a producer of the system model (that is, the user of the system model production support apparatus) inputs, to the system model production support apparatus, information relating to an input to the system model (hereinafter, referred to as “input information for the system model”), and information relating to an output from the system model (hereinafter, referred to as “output information for the system model”), using the input device IPIF. The input information and the output information for the system model may be input by selecting an option appropriate for the system model from among options that are prepared in advance.

Then, when the input information and the output information for the system model are input to the system model production support apparatus, the input-side portion production device ISM produces the input-side portion of the system model, and the output-side portion production device OSM produces the output-side portion of the system model. That is, more specifically, the input-side portion production device ISM produces the input-side portion of the system model by sequentially selecting the partial models constituting the input-side portion of the system model from among the partial models stored in the model storage device PMS in an order starting from the partial model located closest to an input-side end of the system model, based on the input information for the system model, and the input information and the output information for each partial model stored in the model storage device PMS, and sequentially connecting the selected partial models.

The output-side portion production device OSM produces the output-side portion of the system model by sequentially selecting the partial models constituting the output-side portion of the system model from among the partial models stored in the model storage device PMS in an order starting from the partial model located closest to an output-side end of the system model, based on the output information for the system, and the input information and the output information for each partial model stored in the model storage device PMS, and sequentially connecting the selected partial models.

Then, in the system model production support apparatus according to the embodiment, the model connection device CSM connects the input-side portion of the system model produced by the input-side portion production device ISM with the output-side portion of the system model produced by the output-side portion production device OSM, thereby producing the entire system model. The produced system model is output (or displayed) by the output device OPIF.

More specifically, in the system model production support apparatus according to the embodiment, the input-side portion production device ISM selects the partial model located closest to the input-side end of the system model so that at least part of the input information for the partial model located closest to the input-side end of the system model matches the input information for the system model. Also, the input-side portion production device ISM selects the partial models so that at least part of the input information for one of each pair of the adjacent partial models, which is located closer to the output-side end of the system model than the other of the pair of the adjacent partial models is, matches the output information for the other of the pair of the adjacent partial models. Then, the input-side portion production device ISM connects the selected partial models.

The output-side portion production device OSM selects the partial model located closest to the output-side end of the system model so that at least part of the output information for the partial model located closest to the output-side end of the system model matches the output information for the system model. Also, the output-side portion production device OSM selects the partial models so that at least part of the output information for one of each pair of the adjacent partial models, which is located closer to the input-side end of the system model than the other of the pair of the adjacent partial models is, matches the input information for the other of the pair of the adjacent partial models. Then, the output-side portion production device OSM connects the selected partial models.

Further, in the system model production support apparatus according to the embodiment, when the partial model, which is located closest to the output-side end of the system model, in the input-side portion of the system model produced by the input-side portion production device ISM is the same as the partial model, which is located closest to the input-side end of the system model, in the output-side portion of the system model produced by the output-side portion production device OSM, the model connection device CSM connects the input-side portion of the system model with the output-side portion of the system model at the partial model. Accordingly, for example, when the partial model located closest to the input-side end of the system model, which is selected by the input-side portion production device ISM, is the same as the partial model located closest to the output-side end of the system model, which is selected by the output-side portion production device OSM, the system model is constituted by the one partial model.

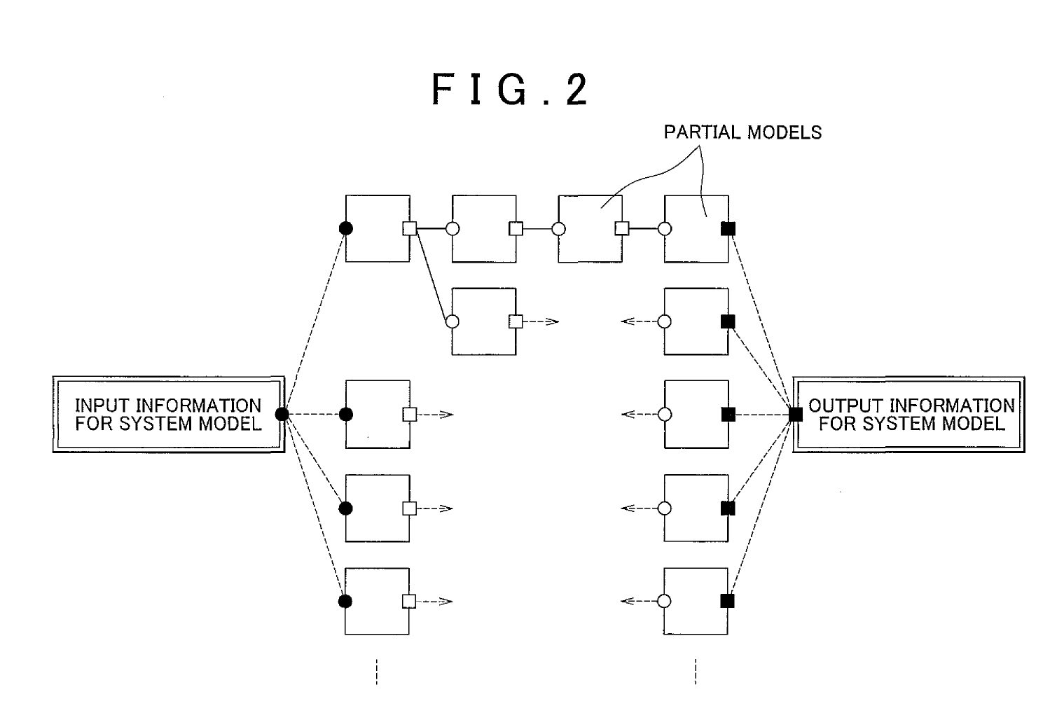

FIG. 2 is a conceptual diagram showing the manner in which a system model production process is performed in the system model production support apparatus according to the embodiment as described above. In an example shown in FIG. 2, one system model in a top row is completed.

As described above, in the system model production support apparatus according to the embodiment, the partial models constituting the input-side portion of the system model are sequentially selected in the order starting from the partial model located closest to the input-side end of the system model, and the selected partial models are sequentially connected; and the partial models constituting the output-side portion of the system model are sequentially selected in the order starting from the partial model located closest to the output-side end of the system model, and the selected partial models are sequentially connected. Then, the input-side portion and the output-side portion of the system model, which are produced in the above-described manner are connected with each other to produce the entire system model. Thus, with the system model production support apparatus according to the embodiment, it is possible to more efficiently produce the system model.

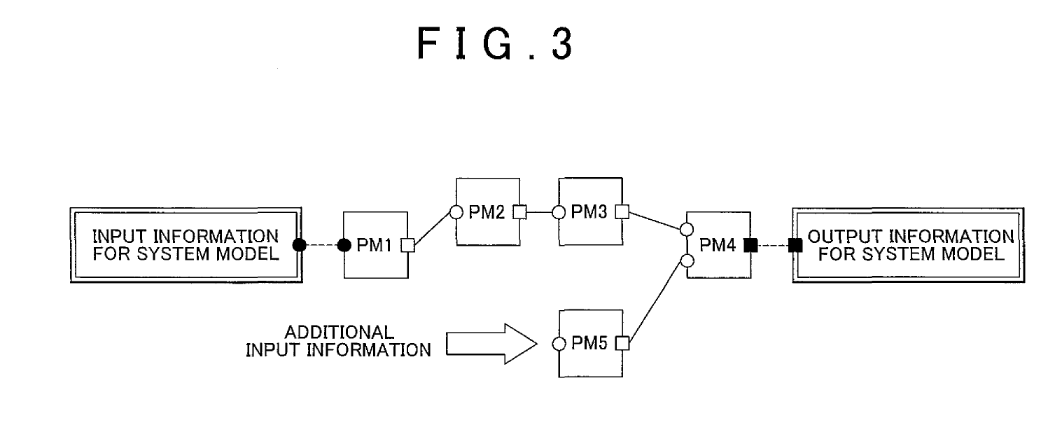

In the system model production support apparatus according to the embodiment, a system model, in which additional input information is necessary, may be produced. That is, the system model as shown in FIG. 3 may be produced (in FIG. 3, the reference characters PM1 to PM5 denote the partial models). The system model, in which additional input information is necessary, is produced, for example, when no partial model is connected to the partial model that has already been connected to the other partial model (i.e., when no partial model is connected to the partial model PM5 that has already been connected to the partial model PM4 in the example shown in FIG. 3).

In this case, the input information for the partial model to which no partial model is connected (i.e., the input information for the partial model PM5 in the example shown in FIG. 3) is necessary as the additional input information, to perform calculation using the system model. When the additional input information is input to the system model production support apparatus, it is possible to perform calculation using the system model. That is, for example, the input information for the partial model PM5 may be the temperature of a coolant for the internal combustion engine (hereinafter, referred to as “engine coolant temperature”) in the example shown in FIG. 3. In this case, when the user inputs the engine coolant temperature (for example, the fixed value of 80° C.) as the additional input information, it is possible to perform calculation using the system model under the condition that the engine coolant temperature is 80° C.

In the above description, when the system model is produced, the user inputs or selects both of the input information and the output information for the system model. However, in other embodiments of the invention, the user may input or select only one of the input information and the output information for the system model. That is, in this case, the output information for the system model may be set according to the input information for the system model, or the input information for the system model may be set according to the output information for the system model. Also, the input information and the output information for the system model may be set according to the user.

When the system model production process is performed based on only the input information and the output information for the system model in the system model production support apparatus according to the above-described embodiment, an extremely large number of system models may be produced as shown in FIG. 2. In this case, it may be necessary for the user to select the most appropriate system model from among the extremely large number of system models that are produced. This may decrease the efficiency of the entire system model production process, that is, the efficiency of the entire process for obtaining a desired system model. Taking this into account, the system model is more efficiently produced in a system model production support apparatus according to another embodiment described below. The system model production support apparatus in the embodiment has many portions in common with the system model production support apparatus in the above-described embodiment. Basically, the description of the common portions will be omitted.

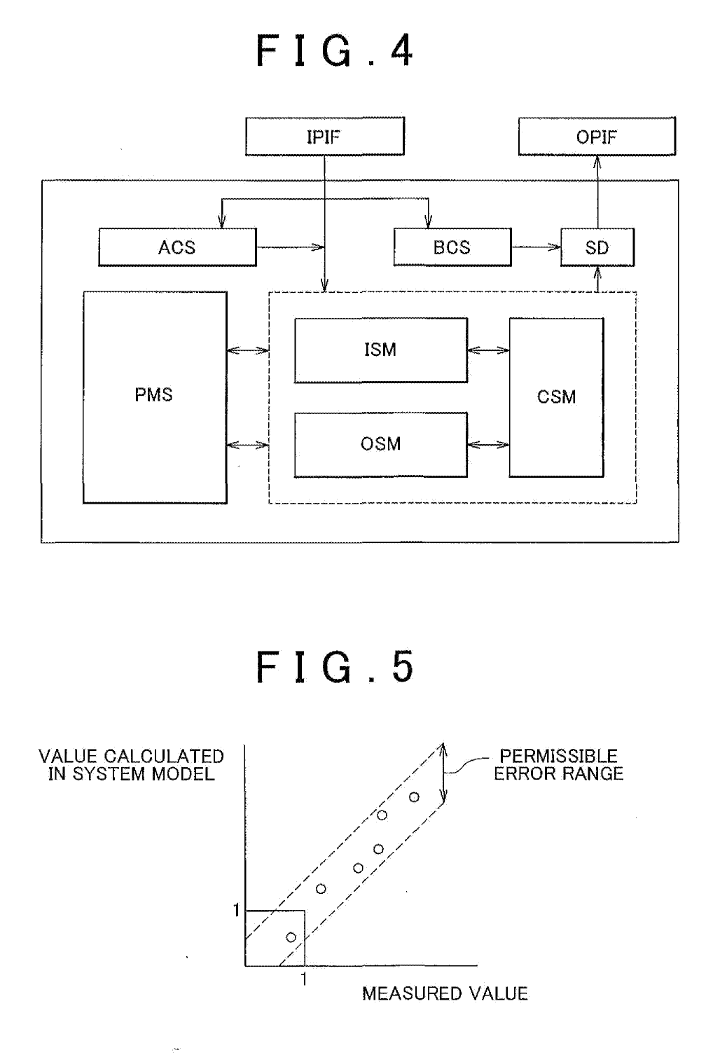

FIG. 4 is a diagram illustrating the configuration of the system model production support apparatus according to the embodiment of the invention that is different from the above-described embodiment. As shown in FIG. 4, the basic configuration of the system model production support apparatus according to the embodiment is the same as the basic configuration (refer to FIG. 1) of the system model production support apparatus according to the above-described embodiment. However, the system model production support apparatus according to the embodiment further includes a system model production condition setting device ACS, a system model selection condition setting device BCS, and a system model selection device SD.

That is, the system model production support apparatus according to the embodiment includes the system model production condition setting device ACS that sets a system model production condition. The system model production condition is an additional condition that is taken into account when a system model is produced. When the system model production condition is set, only the system model that meets the system model production condition is produced. This suppresses production of unnecessary system models, and reduces the number of produced system models. Thus, it is possible to more efficiently produce a desired system model. In the system model production support apparatus according to the embodiment, the user inputs or selects the system model production condition, and the system model production condition setting device ACS sets the system model production condition.

More specifically, in the system model production support apparatus according to the embodiment, for example, a condition relating to the partial model to be used in the system model, a condition relating to the combination of the partial models to be used in the system model, and a condition relating to the output from the partial model in the system model may be set as the system model production conditions. Thus, it is possible to specify the configuration to be included in the system model, and to specify the output from the partial model located at an intermediate position in the system model so that the value of the output from the partial model is obtained when simulation is performed using the system model. Therefore, it is possible to efficiently produce a system model appropriate for the purpose of the simulation. In other embodiments, only one or two of the above-described system model production conditions may be set.

More specifically, for example, in the case where the system model production process is performed using an accelerator-pedal operation amount as the input information for the system model, and using vehicle acceleration as the output information for the system model, system models for systems (vehicles in this case) that include various engines (a hybrid engine, a four-cylinder engine, a six-cylinder engine, an engine with a supercharger, and the like) may be produced unless the system model production condition is set.

In this case, if only a system model of a system that includes an engine with a specific supercharger is necessary, the condition that a model of the specific supercharger is the partial model to be used in the system model is set as the system model production condition. Thus, it is possible to suppress production of unnecessary system models. If a system model of a system that includes an engine with an unspecified supercharger is necessary, the condition that all the supercharger models stored in the model storage device PMS are the partial models to be used in the system model is set as the system model production condition. Thus, it is possible to produce desired system models, while suppressing production of unnecessary system models.

Further, for example, if only a system model of a system that includes a gasoline engine is necessary, the condition that the combination of the partial models constituting the gasoline engine is the combination of the partial models to be used in the system model is set as the system model production condition. Thus, it is possible to suppress production of unnecessary system models.

In the system model production support apparatus according to the embodiment, the user inputs or selects the system model production condition. However, in other embodiments, the system model production condition may be set according to the user. Further, the system model production condition may be set according to at least one of the input information and the output information for the system model.

The system model production support apparatus according to the embodiment may further include the system model selection condition setting device BCS that sets a system model selection condition used to select a specific system model from among produced system models, and the system model selection device SD that selects the system model that meets the system model selection condition, from among the produced system models. Because these devices are provided, a desired system model is efficiently selected from among the produced system models. In the system model production support apparatus according to the embodiment, the user inputs or selects the system model selection condition, and the system model selection condition setting device BCS sets the system model selection condition.

More specifically, in the system model production support apparatus according to the embodiment, a condition relating to a required accuracy and a condition relating to a permissible computation time may be set as the system model selection conditions. Thus, particularly, it is possible to specify the accuracy required in the simulation using the system model, and the computation time permitted in the simulation using the system model. Therefore, it is possible to efficiently produce a system model appropriate for the purpose of the simulation. In other embodiments, only one of the above-described system model selection conditions (i.e., only one of the condition relating to the required accuracy and the condition relating to the permissible computation time) may be set.

More specifically, in the system model production support apparatus according to the embodiment, the system model selection device SD performs calculation in each of the produced system models using an input value for verification, and determines whether each of the system models meets the system model selection conditions (including the condition relating to the required accuracy and the condition relating to the permissible computation time). Thus, the appropriate system model is selected, and the selected system model is output.

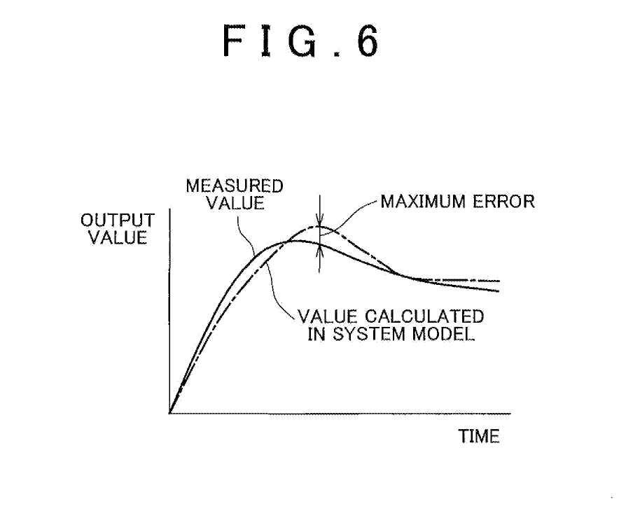

With regard to the required accuracy, a value calculated in each of the produced system models is compared with a value measured in a system to be modeled when the input value for verification is input to the system. Thus, it is determined whether each of the system models meets the condition relating to the required accuracy. That is, more specifically, with regard to a steady-state value, it is determined whether the difference between the value measured in the system and the value calculated in each of the system models is in a permissible error range as shown in, for example, FIG. 5. Thus, it is determined whether each of the system models meets the condition relating to the required accuracy (in FIG. 5, values measured in the system and values calculated in the system model are plotted under the same condition). With regard to a transient value, a time-dependent change in the output value calculated in each of the system models is compared with a time-dependent change in the output value measured in the system as shown in FIG. 6. It is determined whether the maximum value of the error is in a permissible error range. Thus, it is determined whether each of the system models meets the condition relating to the required accuracy.

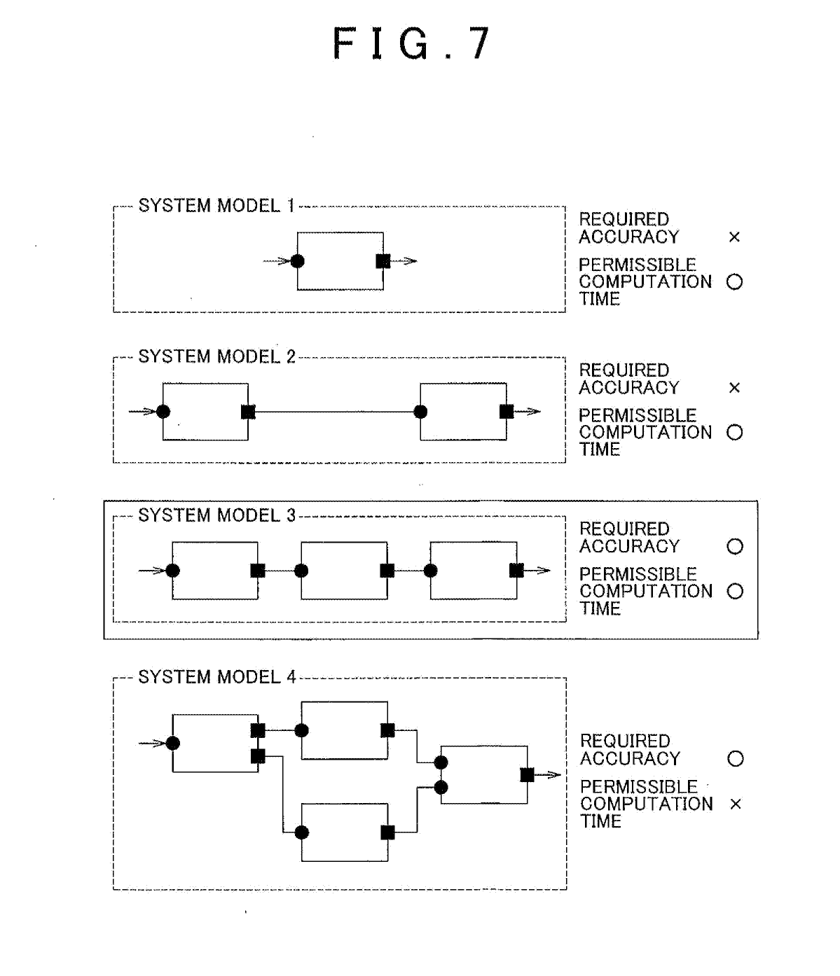

FIG. 7 is a conceptual diagram showing the manner in which a system model is selected in the embodiment. In this example, only a system model 3 meets both of the condition relating to the required accuracy and the condition relating to the permissible computation time, and thus, only the system model 3 is selected (system models 1 and 2 meet the condition relating to the permissible computation time, but do not meet the condition relating to the required accuracy. A system model 4 meets the condition relating to the required accuracy, but does not meet the condition relating to the permissible computation time).

As described above, when the determination relating to the required accuracy is performed, the data, which is measured in the system to be modeled when the input value for verification is input, is necessary. Therefore, the data needs to be obtained in advance, and stored in the system model selection device SD or the like.

When data measured in a system is obtained, and a system model of the system is produced, it is possible to determine the accuracy of the system model using the data. Further, when a system model of another system is produced, by using the system model whose accuracy has been determined as a base model, it is possible to estimate, to some extent, the accuracy of the system model of the other system. Accordingly, when the system model of the other system is produced, by using the system model whose accuracy has been determined as a base model, it is possible to produce the system model of the other system, which has an accuracy close to a desired accuracy.

In the system model production support apparatus according to the embodiment, the user inputs or selects the system model selection condition. However, in other embodiments, the system model selection condition may be set according to the user. Further, the system model selection condition may be set according to at least one of the input information and the output information for the system model.

The system model production support apparatus according to the embodiment includes the system model production condition setting device ACS, the system model selection condition setting device BCS, and the system model selection device SD. However, in other embodiments, only the system model production condition setting device ACS may be provided. Alternatively, only the system model selection condition setting device BCS and the system model selection device SD may be provided.

In each of the above-described embodiments, the system to be modeled may be a portion of the vehicle or the entire vehicle. In this case, the input information for the system model may be a control parameter that is changed to control the vehicle, and the output information for the system model may be a characteristic parameter showing the operating characteristic of the vehicle. Thus, it is possible to efficiently obtain a desired system model in the development of the vehicle using the model.

The control parameter may be, for example, an accelerator-pedal operation amount, a throttle-valve opening amount, an ignition timing, or a controlled variable relating to an actuator, which is controlled to change each of the accelerator-pedal operation amount, the throttle-valve opening amount, and the ignition timing. The characteristic parameter may be, for example, vehicle acceleration, generated torque, or a cylinder pressure.

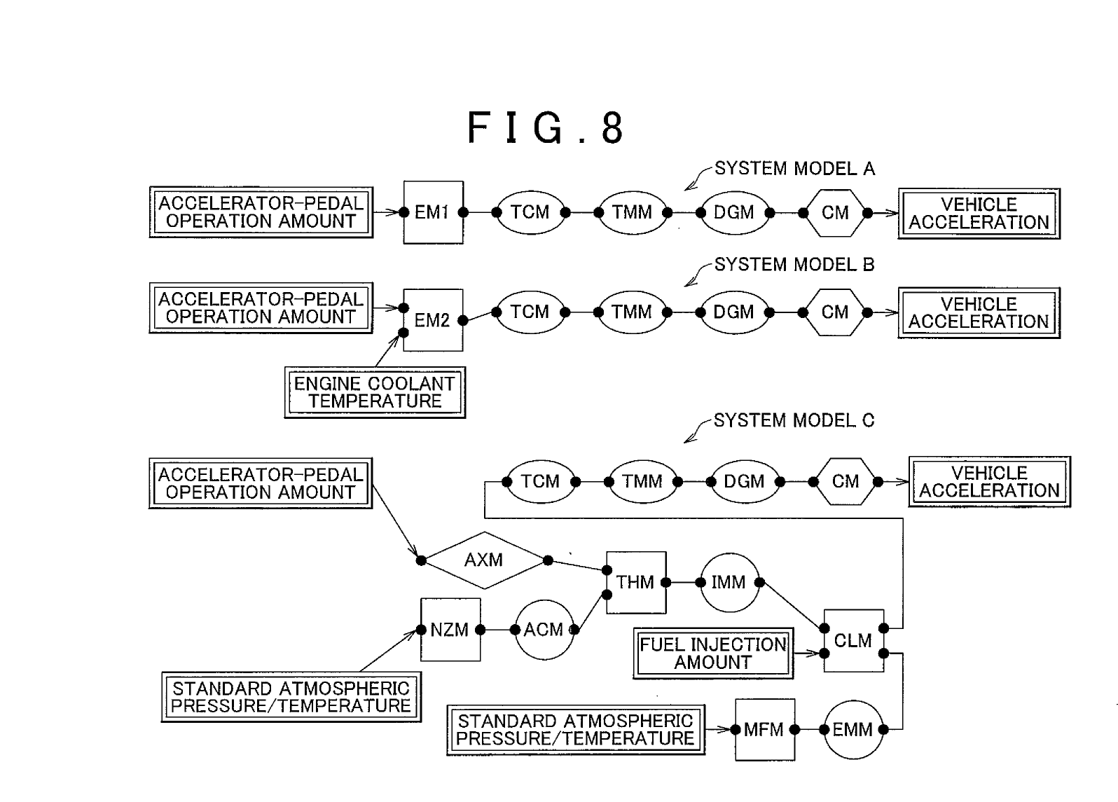

Hereinafter, a specific example, in which the system model production support apparatus according to the invention is used in the development of the vehicle, and system models are produced, will be described. In this example, the accelerator-pedal operation amount is used as the input information for the system model, and the vehicle acceleration is used as the output information for the system model. In this example, when the input information and the output information are used, three system models A, B, and C are produced as shown in FIG. 8.

As shown in FIG. 8, the system model A includes an engine model EM1 and a vehicle body model CM. The engine model EM1 is the partial model located closest to the input-side end. The accelerator-pedal operation amount is input to the engine model EM1. The vehicle body model CM is the partial model located closest to the output-side end. The vehicle acceleration is output from the vehicle body model CM. A torque converter model TCM, a transmission model TMM, and a differential gear model DGM are arranged between the engine model EM1 and the vehicle body model CM in the stated order in a direction from the input-side end to the output-side end. Thus, the engine model EM1, the torque converter model TCM, the transmission model TMM, the differential gear model DGM, and the vehicle body model CM are connected. The system model A has the simplest configuration. That is, the engine portion is constituted by only one partial model (i.e., the engine model EM1). Only the accelerator-pedal operation amount is input to the engine model EM1, and the engine model EM1 outputs indicated torque that is determined without taking into account friction loss in the engine.

In the system model B, an engine model EM 2 is used instead of the engine model EM1 used in the system model A. The accelerator-pedal operation amount and the engine coolant temperature are input to the engine model EM2. The engine model EM2 outputs net torque that is determined taking into account the friction loss in the engine. Accordingly, when the system model B is used, the engine coolant temperature is necessary as the additional input information, and the computation time is longer than when the system model A is used. However, when the system model B is used, it is possible to determine the vehicle acceleration corresponding to the accelerator-pedal operation amount more accurately than when the system model A is used.

Further, in the system model C, a plurality of small portions constituting the engine portion are modeled using a plurality of partial models. That is, in the system model C, the engine portion is constituted by an accelerator model AXM, a nozzle model NZM, an air cleaner model ACM, a throttle model THM, an intake manifold model IMM, a muffler model MFM, an exhaust manifold model EMM, and a cylinder model CLM. The accelerator-pedal operation amount is input to the accelerator model AXM, and the accelerator model AXM converts the accelerator-pedal operation amount to a throttle-valve opening amount, and outputs the throttle-valve opening amount. A fuel injection amount needs to be input to the cylinder model CLM as the additional input information, and the cylinder model CLM outputs the net torque. Further, a standard atmospheric pressure and a standard atmospheric temperature need to be input to the nozzle model NZM and the muffler model MFM as the additional input information.

Thus, in the system model C, the fuel injection amount, and the standard atmospheric pressure and the standard atmospheric temperature are necessary as the additional input information. As described above, because the plurality of small portions constituting the engine portion are modeled using the plurality of partial models, the computation time is long. However, it is possible to more accurately determine the vehicle acceleration corresponding to the accelerator-pedal operation amount. Also, in the system model C, an intake air amount is calculated in a calculation process. Accordingly, for example, when the condition that the intake air amount is calculated is set as the system model production condition, the system models A and B are not produced, and only the system model C is produced.

When the three system models A, B, and C are produced, the system model that meets the set system model selection condition is selected. That is, for example, when the system model selection condition is set to place importance on the short computation time, the system model A is selected. When the high accuracy is required, the system model C is selected. When importance is placed on good balance between the computation time and the accuracy, the system model B is selected.

While the invention has been described with reference to embodiments thereof, it is to be understood that the invention is not limited to the embodiments or constructions. To the contrary, the invention is intended to cover various modifications and equivalent arrangements. In addition, while the various elements of the embodiments are shown in various combinations and configurations, which are exemplary, other combinations and configurations, including more, less or only a single element, are also within the spirit and scope of the invention.

What is claimed is:

1. A system model production support apparatus that supports production of a system model of an entire system to be modeled, using a partial model of each portion constituting the system, comprising:
a model storage device that stores a plurality of the partial models, along with input information and output information for each of the partial models;
an input-side portion production device that produces an input-side portion of the system model by sequentially selecting the partial models constituting the input-side portion of the system model from among the partial models stored in the model storage device in an order starting from the partial model located closest to an input-side end of the system model, based on input information for the system model, and the input information and the output information for each of the partial models, and sequentially connecting the selected partial models;
an output-side portion production device that produces an output-side portion of the system model by sequentially selecting the partial models constituting the output-side portion of the system model from among the partial models stored in the model storage device in an order starting from the partial model located closest to an output-side end of the system model, based on output information for the system, and the input information and the output information for each of the partial models, and sequentially connecting the selected partial models; and
a model connection device that connects the input-side portion of the system model produced by the input-side portion production device, with the output-side portion of the system model produced by the output-side portion production device, thereby producing the entire system model.

2. The system model production support apparatus according to claim 1, wherein:
the input-side portion production device selects the partial model located closest to the input-side end of the system model so that at least part of the input information for the partial model located closest to the input-side end of the system model matches the input information for the system model, the input-side portion production device selects the partial models so that at least part of the input information for one of each pair of the adjacent partial models, which is located closer to the output-side end of the system model than the other of the pair of the adjacent partial models is, matches the output information for the other of the pair of the adjacent partial models, and the input-side portion production device connects the selected partial models; and
the output-side portion production device selects the partial model located closest to the output-side end of the system model so that at least part of the output information for the partial model located closest to the output-side end of the system model matches the output information for the system model, the output-side portion production device selects the partial models so that at least part of the output information for one of each pair of the adjacent partial models, which is located closer to the input-side end of the system model than the other of the pair of the adjacent partial models is, matches the input information for the other of the pair of the adjacent partial models, and the output-side portion production device connects the selected partial models.

3. The system model production support apparatus according to claim 1, wherein
when the partial model, which is located closest to the output-side end of the system model, in the input-side portion of the system model produced by the input-side portion production device is the same as the partial model, which is located closest to the input-side end of the system model, in the output-side portion of the system model produced by the output-side portion production device, the model connection device connects the input-side portion of the system model with the output-side portion of the system model at the partial model.

4. The system model production support apparatus according to claim 1, further comprising
a system model production condition setting device that sets a system model production condition that is taken into account when the system model is produced, wherein when the system model production condition is set, only the system model that meets the system model production condition is produced.

5. The system model production support apparatus according to claim 4, wherein
at least one of a condition relating to the partial model to be used in the system model, a condition relating to a combination of the partial models to be used in the system model, and a condition relating to an output from the partial model in the system model is set as the system model production condition.

6. The system model production support apparatus according to claim 1, further comprising:
a system model selection condition setting device that sets a system model selection condition used to select a specific system model from among the system models that are produced; and
a system model selection device that selects the specific system model that meets the system model selection condition, from among the system models that are produced.

7. The system model production support apparatus according to claim 6, wherein
at least one of a condition relating to a required accuracy and a condition relating to a permissible computation time is set as the system model selection condition.

8. The system model production support apparatus according to claim 1, wherein:
the system to be modeled is a portion of a vehicle or the entire vehicle;
the input information for the system model is a control parameter that is changed to control the vehicle; and
the output information for the system model is a characteristic parameter showing an operating characteristic of the vehicle.

9. A system model production support method that supports production of a system model of an entire system to be modeled, using a partial model of each portion constituting the system, comprising:
storing a plurality of the partial models, along with input information and output information for each of the partial models;
producing an input-side portion of the system model by sequentially selecting the partial models constituting the input-side portion of the system model from among the stored partial models in an order starting from the partial model located closest to an input-side end of the system model, based on input information for the system model, and the input information and the output information for each of the partial models, and sequentially connecting the selected partial models;
producing an output-side portion of the system model by sequentially selecting the partial models constituting the output-side portion of the system model from among the stored partial models in an order starting from the partial model located closest to an output-side end of the system model, based on output information for the system, and the input information and the output information for each of the partial models, and sequentially connecting the selected partial models; and
connecting the produced input-side portion of the system model with the produced output-side portion of the system model, thereby producing the entire system model.

10. The system model production support method according to claim 9, wherein:
the input-side of the system model is produced by selecting the partial model located closest to the input-side end of the system model so that at least part of the input information for the partial model located closest to the input-side end of the system model matches the input information for the system model, selecting the partial models so that at least part of the input information for one of each pair of the adjacent partial models, which is located closer to the output-side end of the system model than the other of the pair of the adjacent partial models is, matches the output information for the other of the pair of the adjacent partial models, and connecting the selected partial models; and
the output-side portion of the system model is produced by selecting the partial model located closest to the output-side end of the system model so that at least part of the output information for the partial model located closest to the output-side end of the system model matches the output information for the system model, selecting the partial models so that at least part of the output information for one of each pair of the adjacent partial models, which is located closer to the input-side end of the system model than the other of the pair of the adjacent partial models is, matches the input information for the other of the pair of the adjacent partial models, and connecting the selected partial models.

11. The system model production support method according to claim 9, wherein when the partial model, which is located closest to the output-side end of the system model, in the input-side portion of the system model is the same as the partial model, which is located closest to the input-side end of the system model, in the output-side portion of the system model, the input-side portion of the system model is connected with the output-side portion of the system model at the partial model.

12. The system model production support method according to claim 9, wherein:
a system model production condition that is taken into account when the system model is produced is set; and
only the system model that meets the system model production condition is produced.

13. The system model production support method according to claim 12, wherein:
at least one of a condition relating to the partial model to be used in the system model, a condition relating to a combination of the partial models to be used in the system model, and a condition relating to an output from the partial model in the system model is set as the system model production condition.

14. The system model production support method according to claim 9, further comprising:
setting a system model selection condition used to select a specific system model from among the system models that are produced; and
selecting the specific system model that meets the system model selection condition, from among the system models that are produced.

15. The system model production support method according to claim 14, wherein at least one of a condition relating to a required accuracy and a condition relating to a permissible computation time is set as the system model selection condition.

16. The system model production support method according to claim 9, wherein the system to be modeled is a portion of a vehicle or the entire vehicle;
the input information for the system model is a control parameter that is changed to control the vehicle; and
the output information for the system model is a characteristic parameter showing an operating characteristic of the vehicle.
